(19) United States
(12) Patent Application Publication
(10) Pub. No.: US 2003/0220806 A1
(43) Pub. Date: Nov. 27, 2003

(54) Information and time managing system and method

(76) Inventors: Kevin Hoffman, Gaithersburg, MD (US); Jim Anzalone, Ashburn, VA (US); Chris Cormack, Ashburn, VA (US)

Correspondence Address: FLESHNER & KIM, LLP, P.O. BOX 221200, CHANTILLY, VA, 20153, US

(21) Appl. No.: 10/310,979

(22) Filed: Dec. 6, 2002

Related U.S. Application Data
(60) Provisional application No. 60/382,387, filed on May 23, 2002.

(51) Int. Cl. G06F 17/60

(52) U.S. Cl. 705/1; 707/2

(57) ABSTRACT

In order to keep track of the activities involved in various business, an information and time management system has been developed. In an embodiment of the invention, several modules have been communicatively coupled to provide a complete and reliable system of keeping a user of the system informed of all due dates and activities.

The application claims priority to U.S. Provisional Application No. 60/382,387, filed May 23, 2002, the entire disclosure of which is hereby incorporated by reference.

### BACKGROUND OF THE INVENTION

1. Field of the Invention

This invention relates generally to an information and time managing system and method that allows users to manage their information and their time with transaction management reports.

2. Background of the Related Art

In order to keep track of due dates and critical information, many systems, such as calendars, electronic organizers, and computer software calendaring programs are employed. However, each of these systems keeps track of the dates in chronological order and is not able to sort information without intervention from a user. As such, time is spent creating separate calendars which are often kept for different purposes and information between each calendar must be manually entered into each calendar. Additionally, in order to review each calendar for each subject matter, each calendar must be reviewed separately and the calendars cannot be readily merged together. Therefore, a system for keeping track of due dates and critical information where predetermined categories can be used to sort due dates and critical information is desired.

### SUMMARY OF THE INVENTION

An object of the invention is to solve at least the above problems and/or disadvantages and to provide at least the advantages described hereinafter.

In order to achieve at least the above objects in whole or in part, and in accordance with the purpose of the invention, as embodied and broadly described, there is provided an information and time managing system accessible by end users, including a folder module adapted to contain information about an item, deadline or transaction, a reports module communicatively coupled to the folder module, wherein the reports module is adapted to search and filter information from the folder module to compile reports for end users of the information from the folder module, a calendar generating module communicatively coupled to at least one of the folder module and the reports module, wherein the calendar generating module includes a data base of stored features, wherein the calendar generating module manipulates information from the folder module using the data base of stored features to compile calendars, and a display interface for displaying reports from the reports module and calendars from the calendar generating module.

To further achieve at least the above objects in whole or in part, and in accordance with the purpose of the present invention, as embodied and broadly described, there is provided a real estate information and time managing system accessible by end users, including a folder module adapted to contain information about an item, deadline or transaction, a reports module communicatively coupled to the folder module, wherein the reports module is adapted to search and filter information from the folder module to compile reports for end users of the information from the folder module, a calendar generating module communicatively coupled to at least one of the folder module and the reports module, wherein the calendar generating module comprises a data base of stored features, wherein the calendar generating module manipulates information from the folder module using the data base of stored features to compile calendars, wherein the reports module comprises a transaction management report module, a due dates report module, an open activities report module, a completion step module, a meeting scheduling module and/or a reports archive module, and wherein the transaction management report module lists at least one pending real estate property for sale or currently under contract, and a display interface for displaying reports from the reports module and calendars from the calendar generating module.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements, wherein:

FIG. 1 is a schematic diagram of an information and time managing system in accordance with an embodiment of the invention;

FIG. 1A is a schematic diagram of an information managing and transferring system in accordance with an embodiment of the invention;

FIG. 1B is a schematic diagram of a listing database of an information managing and transferring system in accordance with an embodiment of the invention;

FIG. 1C is a schematic diagram of a contact database of an information managing and transferring system in accordance with an embodiment of the invention;

FIG. 1D is a schematic diagram of a site database of an information managing and transferring system in accordance with an embodiment of the invention;

FIG. 2 is a schematic diagram of a reports module in accordance with an embodiment of the invention;

FIG. 3 is a schematic diagram of a folder module in accordance with an embodiment of the invention; and

FIG. 4 is a schematic diagram of a calendar generating module in accordance with an embodiment of the invention.

### DETAILED DESCRIPTION OF PREFERRED EMBODIMENTS

Numerous fields of endeavors require information and time managing systems to coordinate due dates and critical information. These fields of endeavors can include but are not limited to, real estate transactions, general contracting, attorney docketing, government case docketing, accounting docketing, sales, delivery, scheduling and access management, where each field requires the integration of due dates and critical information to successfully operate.

Real Estate Transaction System and Method

In the field of real estate transactions, real estate properties must be timely transferred with all of the necessary documentation. Realtors, who are agents typically hired by parties to a real estate transaction, spend considerable amounts of time keeping track of real estate property transaction dates and information to ensure that all of the necessary steps are completed for each and every deadline set forth by contract. The real estate transaction information can include, but is not limited to financial, property and client information.

For example, if a house is offered for sale, a Realtor must keep track of all contingency dates, such as inspections, appraisals, surveys, as well as other contractual dates, such as a closing date or a walk through date. However, due to the complexity of the real estate business and the multiple contracts are often required and must be complied with simultaneously, which can be achieved in accordance with one embodiment of the invention which provides for an information and time managing system for a Realtor to ensure management of real estate transaction information and deadlines.

General Contracting

In order to build a house or other building structure, a general contractor is usually hired to oversee and organize its construction. General contractors are responsible not only for scheduling each phase of a project, ordering supplies and hiring the subcontractors to complete the various phases, but also to schedule each of the phases of construction, subcontractors and supplies in a predetermined order to ensure a timely completion of the project.

The scheduling of the subcontractors and their work must be completed in a particular order to ensure efficient construction and to comply with all the required timing and other requirements. In order to schedule the subcontractors and order the supplies needed by the subcontractors, the general contractor must know the order by which phases must be completed and the amounts of time necessary to complete each phase.

For example, if a foundation subcontractor takes 10 days to complete his or her portion of the project, the general contractor must first hire a foundation subcontractor to arrive on a particular day, then hire a second subcontractor to build upon the foundation 10 days after the foundation subcontractor begins, and so on. If the general contractor waits until the day before the foundation subcontractor completes his portion of the project to order the second subcontractor and his supplies, the second subcontractor or his supplies may not be available in time or may cost more for the short notice given. As such, an information and time managing system and method according to another embodiment of the invention is provided herein to facilitate a general contractor's scheduling of subcontractors and supplies.

Attorney Docketing

In law firms, case assignments and communications between the attorneys, administrators, staff and clients must be monitored in order for the firm to run smoothly. One missed deadline can cost the firm its reputation, cases and clients. As such, all deadlines must be closely monitored at all times.

One problem with current attorney docketing systems is that often, there ate “hard” deadlines required by a court or other authority and “soft” deadlines required internally by a firm or client. For example, for a trial, the court often imposes deadlines for motions, jury instructions, etc., while for a will, an attorney may set a deadline by which they want to get the draft to the client. These dates are often difficult to distinguish using calendars and require attention.

Additionally, most law firms tend to have multiple cases requiring attention simultaneously, where particular attorneys are assigned to several cases and the combinations of attorneys vary from case-to-case. As such, each attorney must attempt to coordinate their actions with the actions of other attorneys in order to effectively handle a case, but such coordination is difficult to facilitate.

Also, clients often need to know the status of their case, as well as the upcoming deadlines for their case. Therefore, a system and method according to another embodiment of the invention is provided herein, which tracks deadlines, case assignments and communications between the attorneys, administrators, staff, and also tracks all clients, matters, actions, details, etc.

Government Case Docketing

In government agencies, such as the Internal Revenue Service (IRS) and/or the Patent and Trademark Office (PTO), knowing the status of filings, notifications and deadlines is essential. Government agencies often have numerous filings and notifications going in and out of each office every day in order to meet statutory deadlines for filings in each agency.

For the IRS, statutory filing deadlines for various income tax returns and their related extensions occur on statutorily preset dates at various times of the year. For example, on every April 15^{th}, personal tax returns are required to be filed. However, the IRS must not only track the filings on and before April 15ₜₕ, but must also track the delinquencies and extensions and also denote the differences for each late filing. Corporate filings also have additional and alternative deadlines and the IRS has a variety of notice requirements such as elections under subclass S, and so forth. Therefore, in order to track and display information for each tax return including their related deadlines, deductions, assessments, refunds and penalties for each tax payer, a system and method of information and time managing is provided herein according to yet another embodiment of the invention.

Additionally, in the PTO, statutory filing deadlines for both applicants and PTO representatives require numerous filings. For example, after an application is filed, a response by the PTO after review of the filing is required. Also, certain communications require a response by the applicant by a certain date. However, similar to the IRS, the PTO must also track late filings, extensions of time, refunds of fees and penalty or late fees for each case to adjust the schedule for response that the PTO must follow. Therefore, in order to keep track of each PTO application, the papers required and submitted and the deadlines associated with each paper filed, a system and method of information and time managing is provided herein according to yet another embodiment of the invention.

Accounting Docketing

For accounting practices, deadlines are often set by clients, as well as the government. In accounting departments within companies, accounts payable and receivable, as well as actual payments, such as payroll, each have predetermined deadlines set forth by service providers and employees.

Also, companies often hire external auditors from accounting businesses to conduct audits. These audits are often conducted in order to report a corporation's assets and liabilities by predetermined deadlines to the government, shareholders and executives of a corporation. These accounting businesses must also keep track of their own clients, as well as their own finances in an organized manner and make sure all financial commitments are handled in a timely manner. As such, in order to keep track of each item requiring attention in an accounting department or by an auditor, a system and method of information and time managing is provided herein according to yet another embodiment of the invention

Sales Transactions

In transaction based sales, businesses must carefully monitor their inventory levels to ensure proper flow of products. As such, businesses must carefully monitor not only the dates at which transactions occur, but also the delivery dates to the customers and from the manufacturer, as well as, the payment dates to the manufacturer and from the customers. Each of these dates must be coordinated in order to ensure a proper inventory level and to ensure the financial solvency of the business.

Often, systems for tracking inventory and tracking accounts receivable and payable are kept separate. The separation of these systems can lead to problems in the business, such as ordering inventory for a customer who is delinquent in his payments. Therefore, in order to keep track the inventory and the accounts, a system and method of information and time managing is provided herein according to yet another embodiment of the invention

Delivery Service Companies

Delivery service companies often have parcels with differing instructions for delivery. Each parcel might differ as to its requirements which include, but are not limited to the routing, the amount of time, the type of delivery, the conditions and the method of shipping, etc. which are required. As such, delivery service companies must track each parcel and their related delivery requirements to ensure that the requirements are met. For example, a delivery service company may have overnight parcels that are fragile or require refrigeration, along with parcels that do not have any special handling requirements and may be delivered after several weeks. Therefore, in order to keep track each parcel and its individual requirements, a system and method of information and time managing is provided herein according to yet another embodiment of the invention.

Scheduling and Access Management

In scheduling and access management applications, accurately and efficiently scheduling people, groups, meetings, rooms, resources, appointments and events is required. Additionally, these schedules must include all information necessary for the scheduling, including the item to be scheduled, the time for the scheduling and any special instructions for the scheduling. These schedules also need to be accessible in order to properly inform scheduled parties and to allow other parties to know the available items and times. For example, if a group of 200 people is scheduling a meeting, a room that can accommodate the 200 people must be reserved for a particular date and time and each person from the group of 200 must be informed. Also, if more than one group of 200 people needs a room for overlapping time periods, a scheduling and access management company must schedule the multiple groups in either the same room with non-overlapping time periods or schedule different rooms.

Scheduling is especially important for large and small businesses for workforce management; service management for service and repair shops (call tracking, work order, technician scheduling and dispatch); and appointments, room reservations or equipment reservations for medical offices/hospitals or other professional practices. Scheduling is also important for workgroup meetings, event and facility management, planning and room reservations for meeting or event schedulers; vacation planning for hotels and resorts; workforce management for temporary hire services; and airline crew scheduling for airline flights on different aircrafts in different cities. Additionally, scheduling is necessary for application management for admissions departments for colleges and universities; equipment reservations and lesson scheduling for flying clubs and schools; and hairstylist reservations for salons, etc. Therefore, in order to keep track of schedules, a system and method of information and time managing is provided herein according to yet another embodiment of the invention.

Preferred Embodiments

In an embodiment of the information and time management system of the invention, which is applicable to but not limited by each of the applications mentioned above, several modules have been communicatively coupled to provide a complete and reliable system of tracking activities and keeping a user informed and prepared at all times. The information and time management system can be made accessible by users, such as Realtors, general contractors, attorneys, government workers, accountants, sales people and shippers, or others and can include a host server with communicatively adapted parts to manage and transfer real estate information.

The host server of the real estate managing and transferring system can include an information compiling section referred to herein as a “reports module,” as well as a storage section referred to herein as a “folder module,” which can be used to store information about selected items of interest, and a scheduling section referred to herein as a “calendar generating module.” The host server can also include other modules, where the term “modules” is intended to include any organized grouping of instructions for a mechanized or computerized device including software for a computer and the programs therein, as well as other types of logic layers or instruction sets that can affect the outcome as instructed.

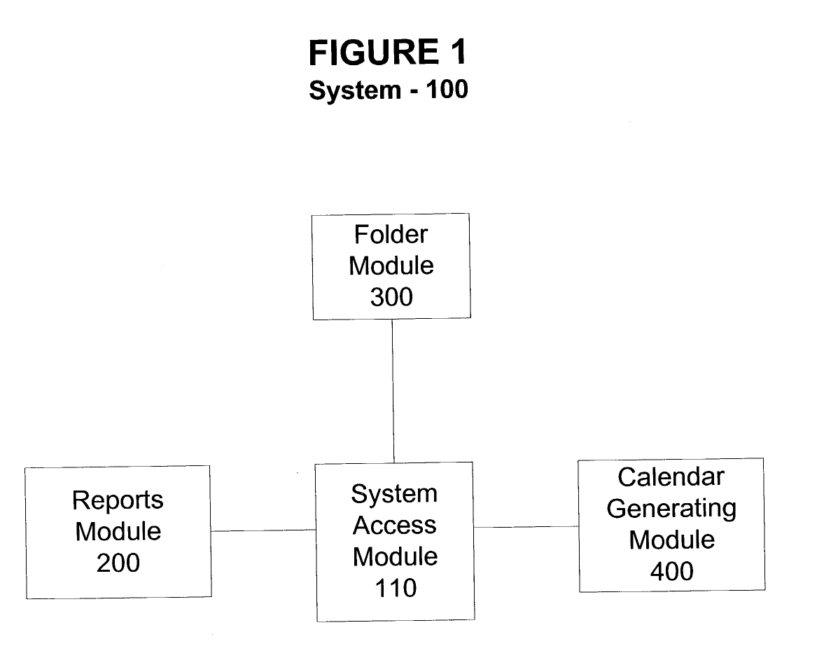

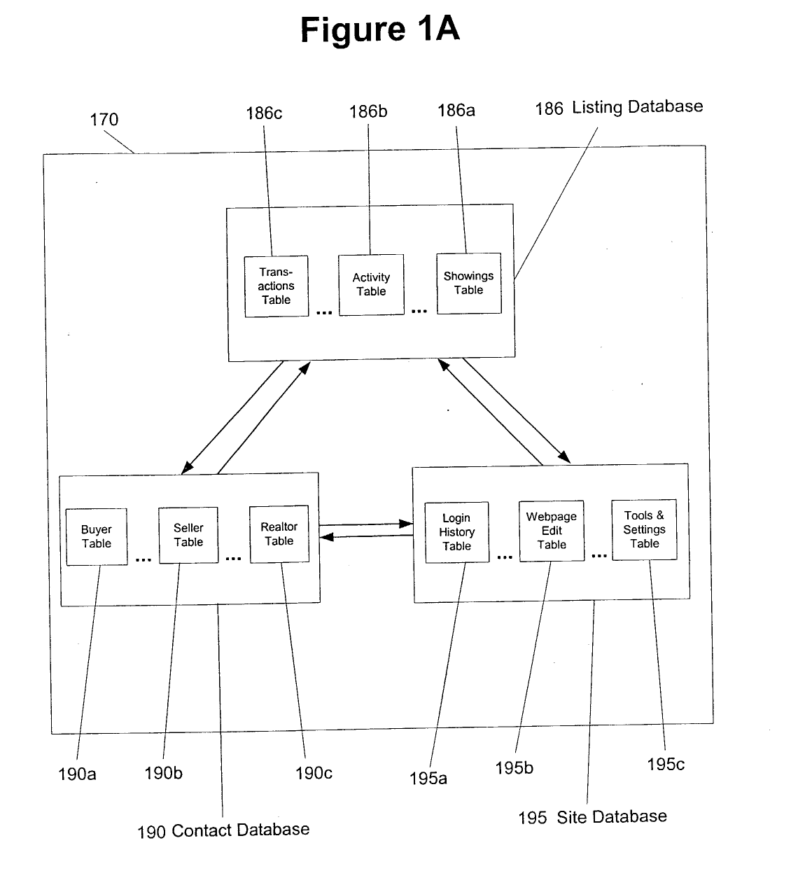

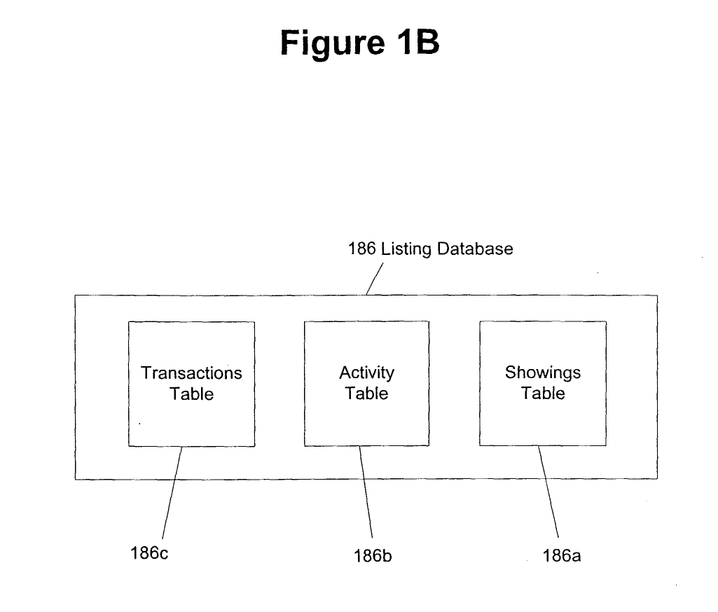

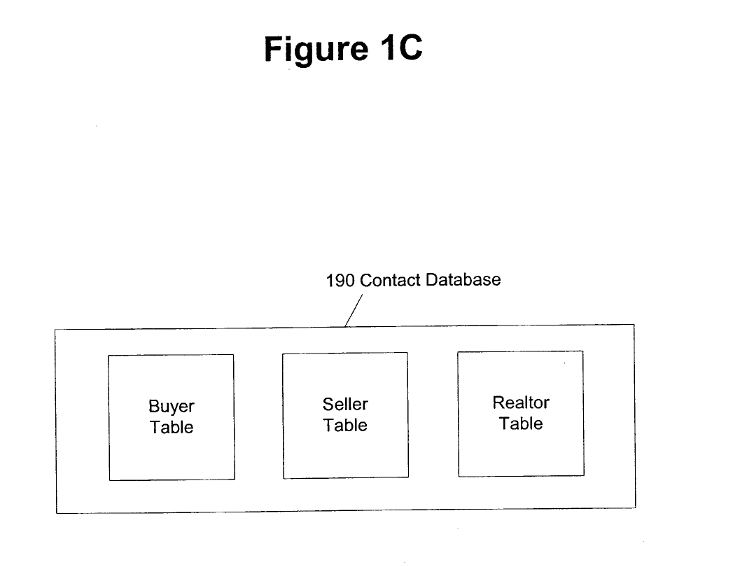

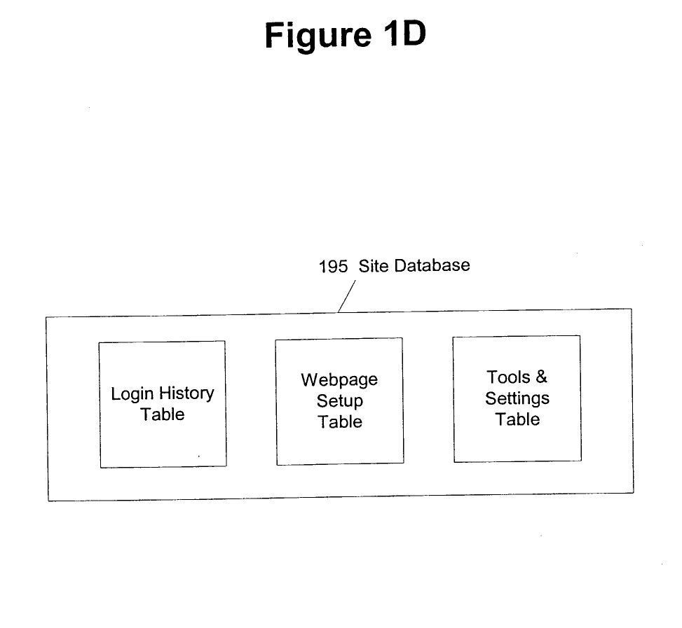

As illustrated in FIG. 1, an information managing and transferring system according to one embodiment of the invention includes a series of modules, including the reports module 200, the folder module 300 and the calendar generating module 400, as mentioned above, which can be communicatively coupled to a system access module 110. Numerous other modules can also be communicatively coupled to the system access module other than the folder module, the calendar generating module and the reports module.

The other modules can include, but are not limited to a showings module, which can be used to determine any parties who inquired about information in the folders module, which depend on the application. For example, parties may be interested in accessing the system for information on a real estate property, an item from a construction project, a legal case file, a government related item, an accounting item, an item for sale from inventory, an item for shipping, etc.

Another module that can be included is a contact management module, which can be used as an integrated list of contact names and addresses for use with the other modules to provide contact information for parties important to a system user. The system can also include a reservation module, which can be used to reserve items necessary for conducting matters for the applicable business that is using the system.

Another module that can be included is a website management module, which can be used to control a website used in the applicable business as an embodiment of displaying the system. Finally, the system can also preferably include a transaction fee coordinating system, which allows payment through a website for services rendered.

Other modules not listed may also be provided based on the particular needs of the user. Each module may be communicatively coupled to the communicative coupler in order to allow a user of the system to gain access to create, modify and/or delete any information desired by the user.

FIG. 1A shows detail of the information managing and transferring system 100. As shown in FIG. 1A the the information managing and transferring system 100 preferably includes separate databases that are communicatively coupled and preferably three separate databases. The three databases include a listing database 186, a contact database 190, and a site database 195. Each database preferably includes a set of tables, which allows information to be entered, sorted, stored, compiled, retrieved, and transferred to other ones of the databases according to prescribed criteria. Although three tables are shown in each of the databases, it should be understood that any number of tables could be included. The set of tables may be developed using any standard platform such as Oracle, Cold Fusion, or preferably Lotus Domino. The software code may be written in any standard programming language, such as JavaScript, HTML, C++, or preferably Lotus Script. Once the databases are created they may be communicatively coupled and viewed seamlessly through an interface. The interface may be uploaded to a website and accessed through the Internet. Accordingly, a user who accesses the databases would do so without knowledge that retrieved information was being provided from the separate databases.

Additional information regarding the listing database 186 is next provided. As shown in FIG. 1B, the listing database preferably includes a set of individual tables within the database. The tables may be used to store data information which may be entered manually or automatically. Although the preferred method of storing information is the use of tables, it should be understood that any mechanism of storing fields of information may be used. Each piece of data used to populate the tables is automatically assigned a unique identifier (ID). For example, in the listing database 186, there may be a plurality of tables, such as a showings table 186a, an activity map table 186, and a transaction manager reports table 186c. Each piece of data used by the system is thus organized in an appropriate table in accordance with its unique ID. Preferably, the unique ID is used to retrieve information from the other databases 190, 195. Table information may include any transaction information that may be used in business transactions such as inventory descriptive information. The table information may be searched by using a character search or a unique ID search.

Additional detail regarding the contact database 190 is next provided. As shown in FIG. 1C, the contact database 190 preferably includes a plurality of tables. For example, the contact database 190 may include a buyer's table 190a, a seller's table 190b, and an agent's table 190c. Each piece of data used to populate the tables is automatically assigned a unique ID. The data is organized in an appropriate table in accordance with the unique ID. Table information may include separate tables for contact information for agents, buyers, sellers, service providers, or any party involved in a business transaction. The contact database 190 includes a contact management module, a contact information memory module, a letter generator module, and a contact information automatic updating module. The contact database may also include an equipment reservation module and a rental rules module. The table information may be searched by using a character search or a unique ID search.

Additional information regarding the site database 195 is next provided. As shown in FIG. 1D, the site database 195 preferably includes a plurality of tables. For example, it may include a login history table 195a, a web page edit table 195b, and a tools and settings table 195c. Each piece of data used to populate the tables is automatically assigned a unique ID. The data is organized in an appropriate table in accordance with the unique ID. Table information may include separate tables for information such as user logon information, website management information, a referrals information, a payment information, and/or any other website management information. The table information may be searched by using a character search or a unique ID search.

Each of the three databases 186, 190, 195 preferably interacts with the other's to manage data and generate various reports. For example, the contact database 190 could work in conjunction with the listing database 186 to generate a letter to a potential buyer after an inventory is shown. Additionally, the invoices generated by the listings database 186 could be coupled with letters generated by the contact database 190. It should be understood that any number of fields could be included in each of the databases, and the above descriptions are given by way of example only. Additionally, it should be understood that certain data items are generated by the various databases, and do not need to be entered manually by a user.

Additional information regarding the interconnectivity between the three databases 186, 190, 195 is next provided. As mentioned above, the information entered into the tables of each database is preferably given a unique identifier (ID). This ID is preferably used to identify and authenticate information. The information in each database is made available to the other databases by using a database linking mechanism, which may be provided by any database platform. It should be noted however, that any linking mechanism may be used.

Preferably, all three databases are interconnected by a database link, which is used to search, retrieve, update, and transfer information. In a preferred embodiment of the present invention at least one of the three databases has to be designated a home database. Preferably, the home database is determined by what database contains the most information regarding a specific query. However any method of determining a home database may be used.

Additional information regarding the home database is next provided. The home database receives a user query and translates the user query into a series of unique IDs. The unique IDs are then transmitted from the home database to the other databases using the database link. Each database gathers the pertinent information based on the unique ID. The result of the gathered information from all three databases is then displayed as a cohesive unit, as a response to the user query. It should be noted that any database may designated the home database.

It should be understood that any number of databases could be used to achieve the same functionality. For example, all of the information could be included in a single database and separated into a plurality of tables. Alternatively, more than three databases could be used.

Additional information regarding a user query is next provided. The user may access the web page and enter query information. For example, the web page may store a plurality of information links for a user to choose from. Each information link is considered a query. For example, one such link is a showings information link. This query consists of information residing on all three databases. The showings information link thus may include information such as an image of inventories, an agent's contact information, and price information. Also included may be information regarding what buyers have purchased similar inventory and what comments were made regarding the quality and price. Once the link is selected, the home database, which is the listing database 186 in this example, receives, organizes, and translates the query into the series of unique IDs. The listing database 186 then pulls from its tables any information involved with that query. The listing database 186 then retrieves a Realtor contact information through the database link from the contact database 190. The listing database 186 then retrieves a user history log-on and feedback information through a database link from the site database 195. The linking database 186 then compiles the information and preferably displays it by loading it onto the Internet web sites The user can then view the information seamlessly through the web site interface.

Also, the preferred embodiment implements a single sign-on mechanism that coordinates log-ons to all three databases in a computer network with preferably one ID and password. Also included may be a master key used to synchronize a set of information entries made on the databases. The synchronization allows for real time update capabilities. For example, if a user provides updated information via the web site interface, the tables in the listing, contact, and site databases 186, 190, 195 automatically receive and update corresponding information. Thus, a user receives all the necessary information from the individual databases without delay. Any application used in creating the databases may include the single sign on mechanism. For example, Microsoft NT, Oracle, SQL, Lotus Notes, or PeopleSoft. Once a user enters the user name and password information the user query may be entered to retrieve pertinent information from the three databases.

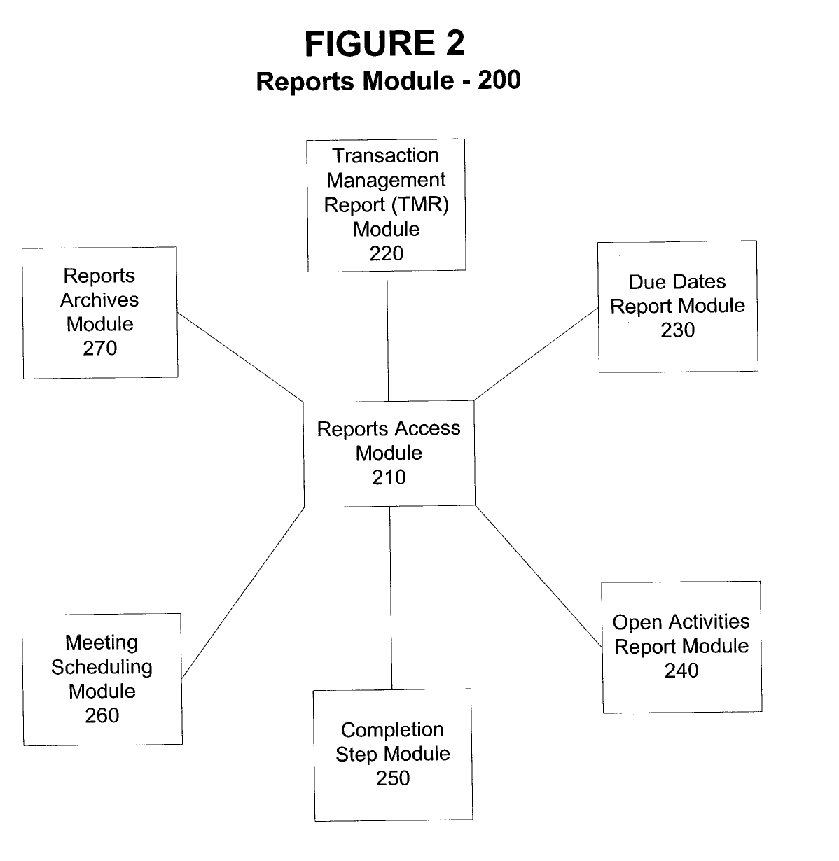

As illustrated in FIG. 2, the reports module 200 contains instructions for the system 100 that organizes the data from the folder module 300 into groups. Each group can be used to generate reports specific to the group selected by the user of the system 100. Using the reports module 200, a user of the system 100 can find all data in the folder module 300 that corresponds to a transaction, due date, open activity, completion step or scheduled meeting.

The reports module may include numerous modules used to create different types of reports. The modules may include any module used for generating reports, including but not limited to a report access module 210 to allow access to the other modules, which may be communicatively coupled to a transaction management report (FMR) module 220 for creating transaction reports, a due dates report module 230 for creating due date reports and an open activities report module 240 for creating open activities reports. The report access module 210 can also be communicatively coupled to a completion step module 250 for creating reports on a completion step of a transaction, a meeting scheduling module 260 for creating reports on scheduled meetings, a reports archives module 270 for archiving previously generated reports, and/or other reports modules.

The report access module 210 may be used by the system to allow access to and from the reports module to and from other modules of the system for information gathering, as well as, for access by the system for exporting the reports to the system. The reports access module 210 can also be used to access any information between the reports module 200 and the rest of the system as needed.

The TMR module 220 of the reports module 200 is used to gather and group data from the folder module 200 into transaction reports. These transaction reports may include transactions that may be pending for any application available. In one embodiment, in a real estate application, the reports would include a list of all real estate property sales pending. In another embodiment, in a general contracting application, all current projects being worked on could be listed in a TMR transaction report.

Also, in another embodiment, for an attorney docketing or a government application, all pending cases can be listed in the transaction report compiled by the TMR module 220. Or in another embodiment, in an accounting application, a report on all accounts can be generated.

Additionally, in another embodiment, in a sales or delivery service company, reports on the statuses of items or parcels can be reported. Finally, in another embodiment, in a scheduling and access management application, the TMR module 220 can be used to generate reports on the reservations made.

The TMR module 220 can display transactions and the like in a list or a calendar format which can include a daily, weekly or monthly format. The TMR module 220 can also include other information along with the transaction information, such as the names of the responsible parties for each activity.

In addition to the transaction reports created by the TMR module 220, due dates reports can be generated on any type of due activity by a due dates report module 230. It is often important to be able to generate a due dates report separately from other reports so as to segregate the due dates from other, perhaps lesser important, dates.

As used in a real estate application or a general contracting application, in another embodiment, the due dates reports would include a list of all contractual due dates, such as inspections and financing. Also, in another embodiment, for an attorney docketing or a government application, all due dates set by a court or statute can be reported in a due dates report. Or in another embodiment, in an accounting application, a report on due dates for accounts payable and accounts-receivable can be generated by the due dates report module 230.

Additionally, in another embodiment, in a sales or delivery service company, reports on the due dates for items, parcels or payments can be generated by the due dates report module 230. Finally, in another embodiment, in a scheduling and access management application, due dates report module 230 can be used to generate reports on the reservations as they arrive.

In addition to the above mentioned modules, an open activities module 240 can be used to generate reports on any open activities. The separation of the open activities from the rest of the activities is important to keep on top of all activities which have not yet been completed, but are still awaiting completion.

As used in a real estate application or a general contracting application, in another embodiment, the open activities reports would include a list of all activities that require attention and completion, such as getting a home inspection, a radon inspection, or financing. Also, in another embodiment, for an attorney docketing or a government application, the open activities report would include any documents that need to be prepared and completed, such as motions or other filing. Or in another embodiment, in an accounting application, a report on open activities, such as bills that have yet to be paid or accounts that need to be serviced can be reported through the open activities report module 240.

Additionally, in another embodiment, in a sales or delivery service company, reports generated by the open activities report module 240 can include deliveries of items, parcels or payments that have not yet been completed. Finally, in another embodiment, in a scheduling and access management application, the open activities report module can be used to generate reports on upcoming reservations or times, places or items that have not yet been reserved.

In addition to the other modules in the reports module 200, a completion step module 250 may also be provided. The completion step module 250 may be configured to list information regarding a completion of a transaction, case or activity and any activity that leads to the closing of the transaction, case or activity. In one embodiment for a real estate application, the completion step module 250 can generate a report on the settlement dates on real estate property transactions.

As used in a general contracting application, in another embodiment, the completion step reports would include the dates in which projects are completed or the days in which the clients take possession of the projects. Also, in another embodiment, for an attorney docketing or a government application, the completion step report would include dates, such as when a decision is handed down in a case, a tax return is paid or a patent application is patented. Or in another embodiment, in an accounting application, the completion step report would include the closing of any accounts, such as when an audit is complete.

Additionally, in another embodiment, in a sales or delivery service company, reports generated by the completion step module 240 can include deliveries of items, parcels or payments that have been completed. Finally, in yet another embodiment, in a scheduling and access management application, the open activities report module can be used to generate reports on reservations that have been completed.

A meeting scheduling module 260 may also be included in the reports module. The meeting scheduling module 260 can be used to generate reports on scheduled appointments or meetings. Using the meeting scheduling module 260, a user of the system 100 can generate reports of all appointments and meetings for a given day or for a given person or place. In one embodiment, in a real estate application, the meeting scheduling report may be configured to list the real estate property showing appointments of a Realtor for a client, as well as meetings between the Realtor and settlement agents, or to schedule open houses at appropriate times in a Realtor's schedule as to not overlap with another commitment that the Realtor may have previously scheduled.

As used in a general contracting application, in another embodiment, the meeting scheduling reports would include the dates and times at which a general contractor meets with clients, subcontractors or suppliers. Also, in another embodiment, in the attorney docketing system, the meeting scheduling report would include dates and times when attorneys may have to be in court or meeting a client. For a government application, in another embodiment, the meeting scheduling report could be used to keep track of appointments made with the public, such as a meeting with a tax payer for an audit or a meeting with an applicant for a patent interview. Or in another embodiment, in an accounting application, the meeting scheduling report would include meetings with clients or employees for audits or gathering information.

Additionally, in another embodiment, in a sales or delivery service company, reports generated by the meeting scheduling module 240 can include dates and times when pick ups and deliveries are expected. Finally, in another embodiment, in a scheduling and access management application, the meeting scheduling report module 240 can be used to generate reports on scheduled meetings.

The reports module 200 may include a reports archives module 270. The reports archives module 270 may be used to store previously generated reports and can be used to archive reports or data entry from any of the modules communicatively coupled thereto. The reports archive module 270 can also be used to access the stored previously generated reports if needed for later comparisons, reuses or other reasons.

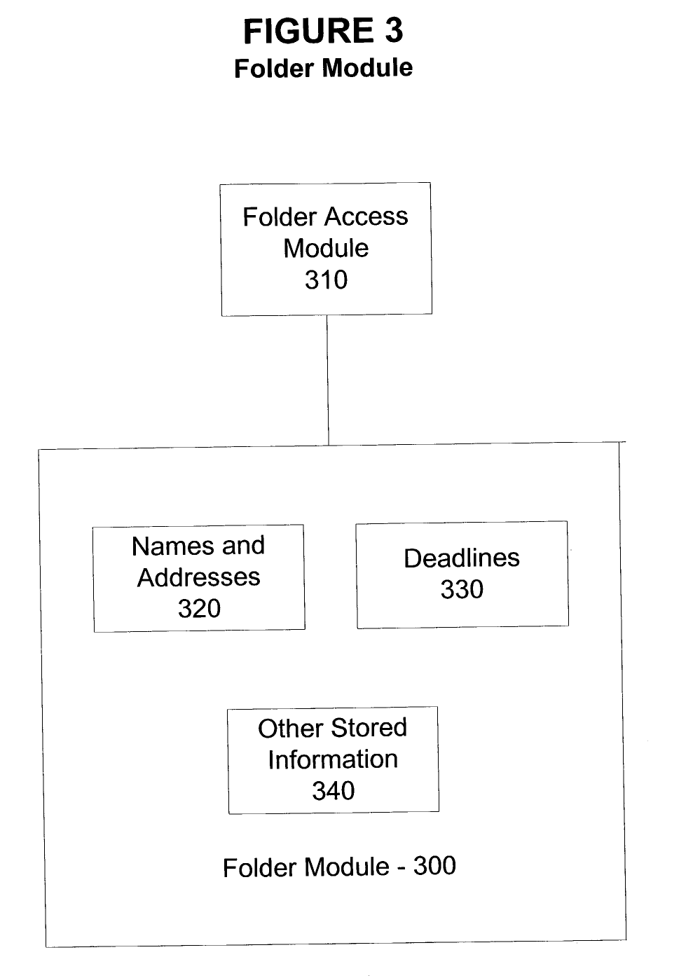

As illustrated in FIG. 3, the folder module 300 contains data for the system 100 which is stored in a manner that enables it to be viewed (or rearranged in some manner) using the other modules in the system 100. The folder module 300 is itself a collection of folders each of which relates to particular transactions. Each of these folders can in turn store information that can be used by the other modules in the system 100.

The folder module 300 includes a folder access module 310, which can be used to store and access information to and from the other modules in the system 100. The folder module 300 may be used to store and access names and addresses 320, deadlines 330 and/or other stored information 340.

In one embodiment, in a real estate application, if a piece of property is being sold, a Realtor will create a folder and insert information such as the names and addresses 320 of the buyer and seller, all the due dates 330, and other information 340, such as the price, the address, size, terms and conditions, and so forth. The folder module 300 facilitates this process by providing the realtor with a form or a series of questions to prompt the Realtor for the required information for that transaction.

In another embodiment, in a general contracting application, names and addresses of the clients, subcontractors and suppliers 320, as well as completion dates for phases of the construction 330 and other information 340, such as the type of wood being used for the framing or the amount of concrete ordered can be stored in the folder module 300. For attorney docketing applications, in another embodiment, names and addresses of clients, outside counsel and other service providers 320, as well as due dates 330 and case information 340 can be stored in the folder module 300.

Also, for government applications, in another embodiment, names and addresses on employees, tax payer or patent applicants 320, as well as deadlines for filings 330 and information on individual cases 340 can be stored in the folder module 300. For accounting applications, in another embodiment, names and addresses of employees 320, deadlines for payroll and accounts payable and receivable 330, as well as cash balances or other accounting information 340 can be stored in the folder module 300.

The folder module 300 can also be used for sales applications, in another embodiment, to store names and addresses of clients and suppliers 320, payment and delivery dates 330, as well as inventory information 340. Additionally, for delivery applications in another embodiment, the folder module 300 can be used to store the names and addresses for each client 320, deadlines for delivery 330 and information on each parcel 340, such as the delivery instructions or routing information. For scheduling applications, in another embodiment, the folder module 300 can be used to store the names and addresses of parties who have made reservations 320, the dates and times of the reservations 330 and information on any reservable items 340.

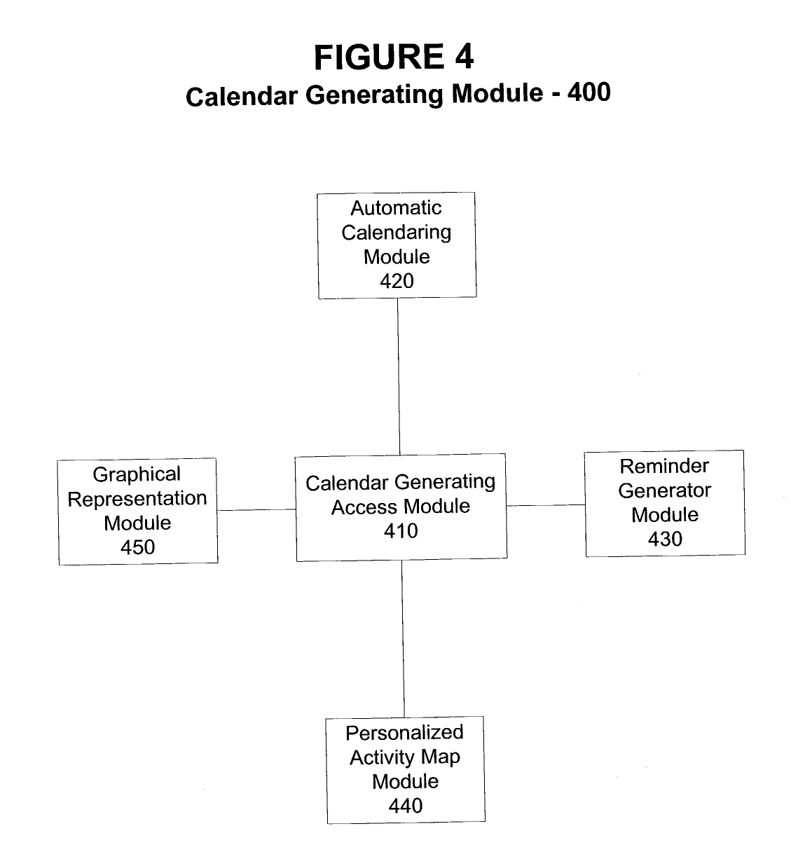

As illustrated in FIG. 4, the calendar generating module 400 contains instructions for the system 100 for automatically generating calendars, reminders, personalized calendars and graphical representation of the calendars. The automatic generation of calendars can occur because of the often repetitive nature of calendars for businesses and organizations. In fact, businesses and organizations, due dates are often set based upon other dates. The calendar generating module 400 uses these known repeating dates to instruct the system 100 to automatically generate activities in a calendar based upon data from the folder module 300.

A calendar generating access module 410 may be provided in the calendar generating module 400 order to allow modules within the calendar generating module 400 to communicate with each other, as well as the system 100.

An automatic calendaring module 420 may also be included in the calendar generating module to provide the automatic calendaring function of the calendar generating module 400. The automatic calendaring module 420 may, for example, be configured to enter dates and tasks into a calendar form as necessary or can automatically calendar other recurring or one time activities or messages from an automatically generated calendar.

In one embodiment, in a real estate application, closing dates are often set one to two months from contracting, inspection contingencies are often set ten days after contracting, etc. As such, knowing the contract date, the closing date can be automatically calendared as two months after the contract date and the inspection contingency dates can be automatically calendared as ten days after calendaring using the automatic calendaring module 420.

In another embodiment, in a general contracting application, subcontractors often take the same amount of time to complete their portion of a project. With this information, a general contractor can use the automatic calendaring module 420 to schedule all of his subcontractors without having to manually input each subcontractor and the number of days for the subcontractor to complete their portion of the project.

For attorney docketing applications, in another embodiment, trials often have preset deadlines that repeat for each case. For example, in civil trials, a court may regularly set a trial date for six months from a settlement conference with motions one month before trial. The automatic calendaring module 420 can use the settlement conference date to generate the remainder of the trial schedule based upon the known date calendaring of the court.

Also, for government applications, in another embodiment, responses to and from citizens is often set by statute. For example, when the PTO sends a rejection of a patent application, response is due by the application within one to six months depending on the type of rejection and whether extensions of time are purchased. The PTO, in turn, must respond to the applicant's response in one to six months. As such, the automatic calendaring module 420 can use the receipt of a filing either to or from the PTO to generate corresponding due dates in a calendar.

For accounting applications, in another embodiment, accounts payable are often regularly scheduled for a certain day within a month or a quarter. The automatic calendaring module 420 can be used to automatically calendar the accounts payable throughout a year.

The automatic calendaring module 420 can also be used for sales applications in another embodiment. For many businesses, delivery dates are regularly scheduled to replenish inventory. As such, the automatic calendaring module 420 can be used to generate a calendar with the regularly scheduled deliveries. Additionally, for delivery applications, in another embodiment, the calendar generating module 400 can be used to generate calendars for regularly scheduled pickups. For scheduling applications, in another embodiment, the automatic calendaring module 420 can be used to schedule any regularly scheduled meetings or follow up meetings that can be predefined in the calendar generating module 400.

In addition to the automatic calendaring module 420, the calendar generating module 400 may also include the reminder generator module 430 which may work in conjunction with the automatic calendaring module 420 to create reminders for tasks, dates and times which may be important. A letter generator may be utilized to create such reminders.

The calendar generating module 400 may also include personalized calendars created by a personalized calendar module 440. The personalized calendar module 440 allows a user of the system 100 to create a personalized calendar for a secondary user. The personal calendar can include any activities as the user of the system wishes to provide for the secondary user.

In one embodiment, in a real estate application, personalized calendars can be used to allow a client to view an entire real estate transaction process including activities a client is not involved in as a Realtor deems appropriate. With the personalized calendar, the client can be better prepared for upcoming events and can be provided with a deeper understanding as to a Realtor's activities which do not involve their client. Thus, the client can see all due dates just completed or open.

Finally, the calendar generating module 400 may also include a graphical representation module 450 which allows any portion of the calendar generating module 400 to be displayed graphically. For example, graphical representations of upcoming dates and tasks could to be displayed via the graphical representation module 450.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An information and time managing system accessible by end users, comprising:
a folder module adapted to contain information about an item, deadline or transaction;
a reports module communicatively coupled to the folder module, wherein the reports module is adapted to search and filter information from the folder module to compile reports for end users of the information from the folder module;
a calendar generating module communicatively coupled to at least one of the folder module and the reports module, wherein the calendar generating module comprises a data base of stored features, wherein the calendar generating module manipulates information from the folder module using the data base of stored features to compile calendars; and
a display interface for displaying reports from the reports module and calendars from the calendar generating module.

2. The system of claim 1, wherein the reports module generates reports which include contingent due dates from the start of a transaction through completion for an individual entry or for multiple entries.

3. The system of claim 1, wherein the reports module highlights due activities and critical tasks in a report.

4. The system of claim 1, wherein the reports module displays activities in a calendar format which can include a daily, weekly or monthly format.

5. The system of claim 1, wherein the reports module displays calendars with names of responsible parties for each activity listed in the calendars.

6. The system of claim 1, wherein the reports module comprises a transaction management report module, a due dates report module, an open activities report module, a completion step module, a meeting scheduling module and/or a reports archive module.

7. The system of claim 6, wherein the reports module comprises a transaction management report module, wherein the transaction management report module comprises an information compiler capable of organizing information and generating reports, and wherein the transaction management report module organizes information into predefined categories and displays the organized information in their predefined categories.

8. The system of claim 7, wherein the transaction management report module generates reports of transactions, cases, accounts, delivery statuses or reservations.

9. The system of claim 7, wherein the transaction management report module displays all activities in a calendar format which includes a daily, weekly or monthly format.

10. The system of claim 7, wherein the transaction management report module generates reports on pending transactions from the folders module.

11. The system of claim 7, wherein the transaction management report module generates reports which include organized listings of any information by predefined category.

12. The system of claim 7, wherein the transaction management report module is used for real estate transactions and generates a report of pending real estate property sales.

13. The system of claim 7, wherein the transaction management report module is used for general contracting purposes and generates a report of active current projects.

14. The system of claim 7, wherein the transaction management report module is used for attorney docketing and generates a report of pending cases.

15. The system of claim 7, wherein the transaction management report module is used for government case docketing and generates a report of pending cases.

16. The system of claim 7, wherein the transaction management report module is used for accounting docketing and generates a report of pending accounts.

17. The system of claim 7, wherein the transaction management report module is used for sales applications and generates a report on items or parcels pending sales completion.

18. The system of claim 7, wherein the transaction management report module is used for delivery services and generates a report on items or parcels pending delivery completion.

19. The system of claim 7, wherein the transaction management report module is used for scheduling and access management applications and generates a report on reservation made.

20. A real estate information and time managing system accessible by end users, comprising:
a folder module adapted to contain information about a Realtor, a real estate property location, features and price, a new construction property location, features and price, transaction deadlines or names and addresses of parties to a real estate transaction;
a reports module communicatively coupled to the folder module, wherein the reports module is adapted to search and filter information from the folder module to compile reports on real estate transaction due dates, inspection dates, financing dates, settlement dates, transactions dates or completion date for end users of the information from the folder module, and wherein the reports module comprises a transaction management report module, a due dates report module, an open activities report module, a completion step module, a meeting scheduling module and/or a reports archive module, and wherein the transaction management report module lists at least one pending real estate property for sale or currently under contract;
a calendar generating module communicatively coupled to at least one of the folder module and the reports module, wherein the calendar generating module comprises a data base of stored features, wherein the calendar generating module manipulates information from the folder module using the data base of stored features to compile calendars of closing dates, contract contingency dates, inspection dates and/or settlement dates; and
a display interface for displaying reports from the reports module and calendars from the calendar generating module.

21. A general contracting information and time managing system accessible by end users, comprising:
a folder module adapted to contain names and addresses of clients, subcontractors and suppliers, completion dates for phases of a construction, and/or supplies needed for the construction;
a reports module communicatively coupled to the folder module, wherein the reports module is adapted to search and filter information from the folder module to compile reports on due dates, open activities, current projects under construction, and/or future projects for future construction for end users, and wherein the reports module comprises a transaction management report module, a due dates report module, an open activities report module, a completion step module, a meeting scheduling module and/or a reports archive module, and wherein the transaction management report module lists at least one of the current projects under construction by a general contractor;
a calendar generating module communicatively coupled to at least one of the folder module and the reports module, wherein the calendar generating module comprises a data base of stored features, wherein the calendar generating module manipulates information from the folder module using the data base of stored features to compile calendars with estimated dates of construction and completion for projects or specific subcontractors and completion dates for each subcontractor's associated portions of the projects; and
a display interface for displaying reports from the reports module and calendars from the calendar generating module.

22. An attorney docketing information and time managing system accessible by end users, comprising:
a folder module adapted to contain names and addresses of clients, outside contacts or other contacts, due dates or case information;
a reports module communicatively coupled to the folder module, wherein the reports module is adapted to search and filter the names and addresses of clients, outside contacts or other contacts, due dates or case information from the folder module to compile reports for end users of the names and addresses of clients, outside contacts or other contacts, due dates or case information from the folder module, and wherein the reports module comprises a transaction management report module, a due dates report module, an open activities report module, a completion step module, a meeting scheduling module and/or a reports archive module, and wherein the transaction management report module lists at least one of the pending cases for an attorney;
a calendar generating module communicatively coupled to at least one of the folder module and the reports module, wherein the calendar generating module comprises a data base of stored features, wherein the calendar generating module manipulates the names and addresses of clients, outside contacts or other contacts, due dates or case information from the folder module using the data base of stored features to compile calendars with preset trial deadlines, settlement conference dates, trial schedules or other docket related dates; and
a display interface for displaying reports from the reports module and calendars from the calendar generating module.

23. A government case docketing information and time managing system accessible by end users, comprising:
a folder module adapted to contain names and addresses of clients, subcontractors or suppliers, construction information, completion dates for phases and/or supply information;
a reports module communicatively coupled to the folder module, wherein the reports module is adapted to search and filter the names and addresses of clients, subcontractors or suppliers, construction information, completion dates for phases and/or supply information from the folder module to compile reports for end users of the names and addresses of clients, subcontractors or suppliers, construction information, completion dates for phases and/or supply information from the folder module, and wherein the reports module comprises a transaction management report module, a due dates report module, an open activities report module, a completion step module, a meeting scheduling module and/or a reports archive module, and wherein the transaction management report module lists at least one of the pending cases in a government agency;
a calendar generating module communicatively coupled to at least one of the folder module and the reports module, wherein the calendar generating module comprises a data base of stored features, wherein the calendar generating module manipulates the names and addresses of clients, subcontractors or suppliers, construction information, completion dates for phases and/or supply information from the folder module using the data base of stored features to compile calendars; and
a display interface for displaying reports from the reports module and calendars from the calendar generating module.

24. An accounting docketing information and time managing system accessible by end users, comprising:
a folder module adapted to contain names and addresses of clients, employees or other contacts, accounts payable and/or receivable information, cash balances, payment dates and/or audit dates;
a reports module communicatively coupled to the folder module, wherein the reports module is adapted to search and filter the names and addresses of clients, employees or other contacts, accounts payable and/or receivable information, cash balances, payment dates and/or audit dates from the folder module, and wherein the reports module comprises a transaction management report module, a due dates report module, an open activities report module, a completion step module, a meeting scheduling module and/or a reports archive module, and wherein the transaction management report module lists at least information from a pending account or an employee;
a calendar generating module communicatively coupled to at least one of the folder module and the reports module, wherein the calendar generating module comprises a data base of stored features, wherein the calendar generating module manipulates the names and addresses of clients, employees or other contacts, accounts payable and/or receivable information, cash balances, payment dates and/or audit dates from the folder module using the data base of stored features to compile calendars; and
a display interface for displaying reports from the reports module and calendars from the calendar generating module.

25. A sales transaction information and time managing system accessible by end users, comprising:
a folder module adapted to contain names and addresses of clients and suppliers, payment and delivery dates, and/or inventory information;
a reports module communicatively coupled to the folder module, wherein the reports module is adapted to search and filter the names and addresses of clients and suppliers, payment and delivery dates, and/or inventory information from the folder module to compile reports for end users of the names and addresses of clients and suppliers, payment and delivery dates, and/or inventory information from the folder module, and wherein the reports module comprises a transaction management report module, a due dates report module, an open activities report module, a completion step module, a meeting scheduling module and/or a reports archive module, and wherein the transaction management report module lists a sales status of at least one of the items for sale;
a calendar generating module communicatively coupled to at least one of the folder module and the reports module, wherein the calendar generating module comprises a data base of stored features, wherein the calendar generating module manipulates the names and addresses of clients and suppliers, payment and delivery dates, and/or inventory information from the folder module using the data base of stored features to compile calendars; and
a display interface for displaying reports from the reports module and calendars from the calendar generating module.

26. A delivery service information and time managing system accessible by end users, comprising:
a folder module adapted to contain names and addresses of clients, deadlines for deliveries, delivery instructions, parcel information, and/or payment information;
a reports module communicatively coupled to the folder module, wherein the reports module is adapted to search and filter the names and addresses of clients, deadlines for deliveries, delivery instructions, parcel information, and/or payment information from the folder module to compile reports for end users of the names and addresses of clients, deadlines for deliveries, delivery instructions, parcel information, and/or payment information from the folder module, and wherein the reports module comprises a transaction management report module, a due dates report module, an open activities report module, a completion step module, a meeting scheduling module and/or a reports archive module, and wherein the transaction management report module lists the delivery status at least one of the parcels for delivery by the delivery service;
a calendar generating module communicatively coupled to at least one of the folder module and the reports module, wherein the calendar generating module comprises a data base of stored features, wherein the calendar generating module manipulates the names and addresses of clients, deadlines for deliveries, delivery instructions, parcel information, and/or payment information from the folder module using the data base of stored features to compile calendars; and
a display interface for displaying reports from the reports module and calendars from the calendar generating module.

27. A scheduling and access management information and time managing system accessible by end users, comprising:
a folder module adapted to contain names and addresses of parties who have made reservations or are part of the reservation, dates and times of reservations and/or information on reserve-able items;
a reports module communicatively coupled to the folder module, wherein the reports module is adapted to search and filter the names and addresses of parties who have made reservations or are part of the reservation, dates and times of reservations and/or information on reserve-able items from the folder module to compile reports for end users of the names and addresses of parties who have made reservations or are part of the reservation, dates and times of reservations and/or information on reserve-able items from the folder module, and wherein the reports module comprises a transaction management report module, a due dates report module, an open activities report module, a completion step module, a meeting scheduling module and/or a reports archive module, and wherein the transaction management report module lists at least one reservation in the system;
a calendar generating module communicatively coupled to at least one of the folder module and the reports module, wherein the calendar generating module comprises a data base of stored features, wherein the calendar generating module manipulates the names and addresses of parties who have made reservations or are part of the reservation, dates and times of reservations and/or information on reserve-able items from the folder module using the data base of stored features to compile calendars; and
a display interface for displaying reports from the reports module and calendars from the calendar generating module.
